(19) United States
(12) Patent Application Publication
(10) Pub. No.: US 2011/0167975 A1
(43) Pub. Date: Jul. 14, 2011

(54) CUTTING HEAD WITH CHIP COLLECTION FOR CUTTING A TUBULAR OBJECT

(76) Inventors: Éric Boudreault, Sainte-Julie (CA); Pierre Gauthier, Trois-Rivieres (CA); Eric Lavoie, Montreal (CA)

(21) Appl. No.: 12/737,479

(22) PCT Filed: Jul. 15, 2009
(86) PCT No.: PCT/CA2009/000955

§ 371 Date: Mar. 21, 2011

(30) Foreign Application Priority Data
Jul. 18, 2008 (CA) 2637649

(51) Int. Cl. B26D 7/18; B26D 3/16

(52) U.S. Cl. 83/100

(57) ABSTRACT

A cutting head with chip collection for cutting a tubular object. The cutting head comprises a frame and gripping, cutting, advancing and sealing units. The gripping unit is used to grip the object and secure its position with respect to the frame. The cutting unit has a motor driving a blade for cutting the tubular object. The advancing unit is used to guide the cutting unit in order to vary a cutting depth of the blade through a cutting area defined by an opening of the frame. The sealing unit has members extending around the cutting area and forming a chamber to contain the chips produced by the blade during a cutting. A suction conduit communicating with the chamber allows drawing the chips and conveying them toward a chip collecting outlet.

### FIELD OF THE INVENTION

The invention relates to a cutting head with chip collection for cutting a tubular object like a feeder pipe of a nuclear reactor, a contaminated pipe, or other types of objects like a metal or plastic cylinder, hollow or solid.

### BACKGROUND

The dismantling of certain components of a nuclear reactor, like its feeder pipes for example in order to replace them to allow extending the useful life of the reactor, is a task calling for many precautions, and requires in particular the cutting of the pipes to facilitate their handling, without releasing splinters or chips that may contaminate the work environment.

The conventional cutting tools like commercial electric saws are not adapted to such a task. They are generally too cumbersome and cannot reach the often tight spaces around the pipes. They are generally not remotely operable, for example by means of a manipulator arm. They are also generally not adapted to make a precise cut of a pipe or a cylindrical or tubular element.

Although certain cutting tools may be equipped with splinter and chip suction systems, these systems are generally rudimentary and a non-negligible portion of the splinters and chips is likely to be released in the environment.

Besides the nuclear field, similar needs for cutting or severing pipes or tubular or cylindrical objects while avoiding contamination risks exist, as in the construction field where the pipes may be contaminated with lead or mercury, and in the medical and biochemical industry fields where the pipes may be used to convey certain pathogenic biological agents.

### SUMMARY

An object of the present invention is to provide a cutting head allowing to cut by turns several feeder pipes of a nuclear reactor while collecting the chips in order to avoid a radioactive contamination in the environment.

Another object of the present invention is to provide such a cutting head that may have a compact configuration allowing its use in tight locations.

Another object of the present invention is to provide such a cutting head that may have a configuration mountable at the end of a manipulator arm.

Another object of the present invention is to provide such a cutting head that has an improved efficiency for collecting splinters and chips resulting from the cutting.

Another object of the present invention is to provide such a cutting head that may also be used to cut other kinds of tubular or cylindrical objects, hollow or solid.

According to an aspect of the present invention, there is provided a cutting head with chip collection for cutting a tubular object, comprising:
a frame having an opening defining a cutting area intended to receive the tubular object crosswise;
a gripping unit for gripping the tubular object and securing a position of the tubular object with respect to the frame when the tubular object is engaged in the cutting area;
a cutting unit having a blade for cutting the tubular object, and a motor coupled to the blade for driving it in operation;
a blade advancing unit guiding the cutting unit in order to vary a cutting depth of the blade across the cutting area;
a sealing unit having members extending around the cutting area and forming a chamber around a portion of the tubular object when the tubular object is engaged in the cutting area to contain the chips produced by the blade during a cutting of the tubular object; and
a suction conduit communicating with the chamber for drawing the chips contained in the chamber and conveying them toward a chip collecting outlet disposed away from the cutting area.

### BRIEF DESCRIPTION OF THE DRAWINGS

A detailed description of preferred embodiments will be given herein below with reference to the following drawings, in which like numbers refer to like elements:

FIG. 1 is an exploded perspective schematic view of a cutting head with chip collection according to the present invention.

FIG. 2 is a bottom perspective schematic view of the cutting head.

FIG. 3 is a top perspective schematic view of the cutting head.

FIG. 4 is a perspective schematic view of a gripping unit of the cutting head.

FIG. 5 is a bottom schematic view of a cutting area illustrating preferred positions for pipes having different diameters.

FIG. 6 is a perspective schematic view of a carriage of an advancing unit of the cutting head.

FIG. 7 is a perspective schematic view of a cutting unit of the cutting head.

FIG. 8 is a partial exploded elevation schematic view of a fastening arrangement of the blade of the cutting unit.

FIGS. 9 and 10 are partial perspective schematic views of an upper portion of a sealing unit of the cutting head, without and with a pipe to be cut.

FIG. 11 is a partial exploded perspective schematic view of a sealing unit of the cutting head.

FIG. 12 is a partial schematic view of an actuation mechanism of the jaws of the sealing unit.

FIG. 13 is a perspective schematic view of a frame of the cutting head.

### DETAILED DESCRIPTION OF PREFERRED EMBODIMENTS

As used herein, the term “tubular object” corresponds to any object of tubular form, hollow or solid (e.g. cylindrical), having a round, square or other cross-section.

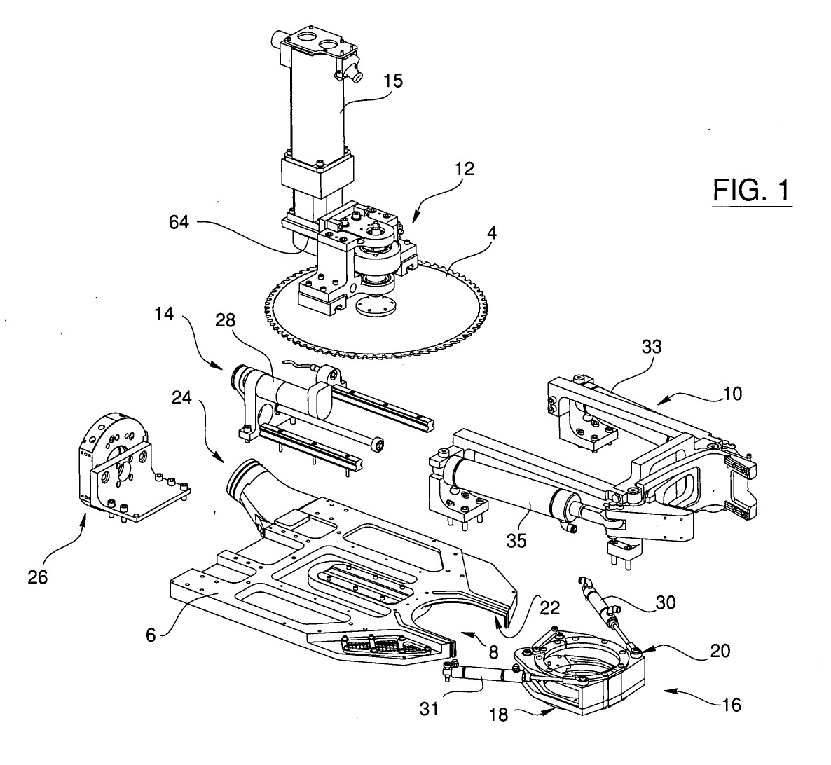

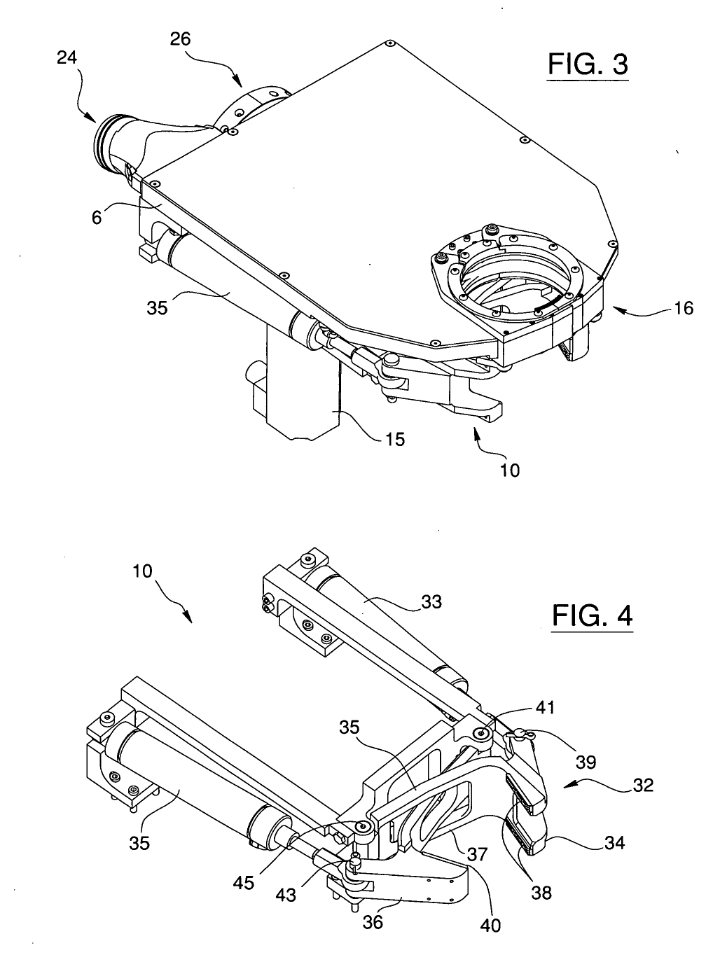

Referring to FIGS. 1, 2 and 3, there is shown a construction of the cutting head with chip collection for cutting a tubular object 2, as shown in FIG. 10, according to the invention. The cutting head allows in particular controlling and collecting the chips resulting from a cutting operation with a blade 4, such as a circular saw blade, in order to cut objects without releasing splinters in the environment.

The cutting head comprises a frame 6 having an opening 8 defining a cutting area for receiving the tubular object 2 crosswise. To achieve a clean cutting operation, the cutting head also comprises various mechanical units, namely a gripping unit 10, a cutting unit 12, an advancing unit 14 of the blade 4, and a sealing unit 16. The frame 6 preferably has a flat shape and a front portion comprising the opening 8. The blade then extends in a longitudinal plane of the frame 6.

The gripping unit 10 is mounted on the frame 6 to grip the tubular object 2 and secure a position of the tubular object 2 with respect to the frame 6 when the tubular object 2 is engaged in the cutting area.

The cutting unit 12 comprises the blade 4, which must be suitable for cutting the tubular object 2, and a motor 15 coupled to the blade 4 to drive it in operation. In the illustrated case, the motor 15 may be coupled so as to adjust the rotation of the blade 4.

The advancing unit 14 is mounted on the frame 6 and is capable of moving the cutting unit 12 in order to vary a cutting depth of the blade 4 across the cutting area. The advancing unit 14 thus allows achieving a cutting at a constant removal rate of metal or other material.

The sealing unit 16 is mounted on the frame 6 and has members 18, 20 extending around the cutting area to form a chamber around a portion of the tubular object 2 when the tubular object 2 is engaged in the cutting area in order to contain the chips produced by the blade 4 during a cutting of the tubular object 2. The sealing unit 16 thus allows sealing the opening 8 of the frame 6 around the object 2 (or cylinder) to be cut.

The cutting head also comprises a suction conduit 22 (better shown in FIG. 13) communicating with the chamber defined by the members 18, 20 of the sealing unit 16, to draw the chips contained in the chamber and convey them toward a chip collecting outlet 24 disposed away from the cutting area. Thus, during the cutting, the particles or chips are confined and collected by a suction system (not shown) coupled to the collecting outlet 24.

The cutting head may be provided with a quick connect type interface 26 making a link between the cutting head and a manipulator arm (not shown). The operations of the cutting head may be controlled by software via an electronic circuit (not shown) mounted or not in the cutting head, connected to and operating two electric motors 15, 28 and four pneumatic cylinders 30, 31, 33, 35. The connector 26 may for this purpose have a communication interface for receiving control signals intended to the gripping, cutting, advancing and sealing units 10, 12, 14, 16.

With the exception of the cutting unit 12 which is mounted on the advancing unit 14, all the mechanical units 10, 14, 16 of the cutting head are fastened on the frame 6 (directly or through intermediate pieces if desired) that may act as a casing to the cutting head. In the illustrated case, the frame 6 stiffens the cutting head in addition to retaining the chips.

Referring to FIG. 4, the gripping unit 10 is used to temporarily fasten the cutting head to the object 2 to be cut. The gripping unit 10 allows stabilizing the cutting and preventing the manipulator arm (not shown) from being overused. Furthermore, it allows positioning the object 2, e.g. a pipe, in the sealing unit 16 (shown for example in FIG. 1) and handling it after the cutting.

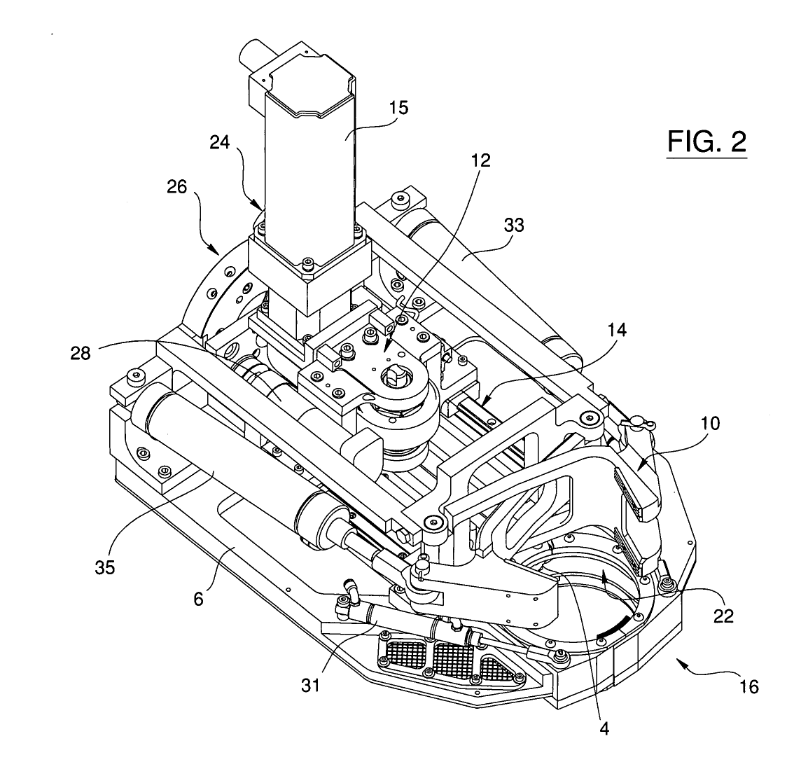

The gripping unit 10 comprises a clamp 32 extending below the opening 8 of the frame 6 (as shown in FIG. 2) and having jaws 34, 36 operable between an open position allowing engagement of the tubular object 2 in the cutting area, and a gripping position in which the jaws 34, 36 exert a pressure against the tubular object 2 so as to secure it with respect to the frame 6. Pneumatic cylinders 33, 35 are coupled to the jaws 34, 36 so as to operate the clamp 32 between the open and gripping positions.

Preferably, the jaws 34, 36 have heads exhibiting inner faces provided with pads 38, 40 and incurved one toward the other to adapt at least in part to a perimeter of the tubular object 2 to be cut.

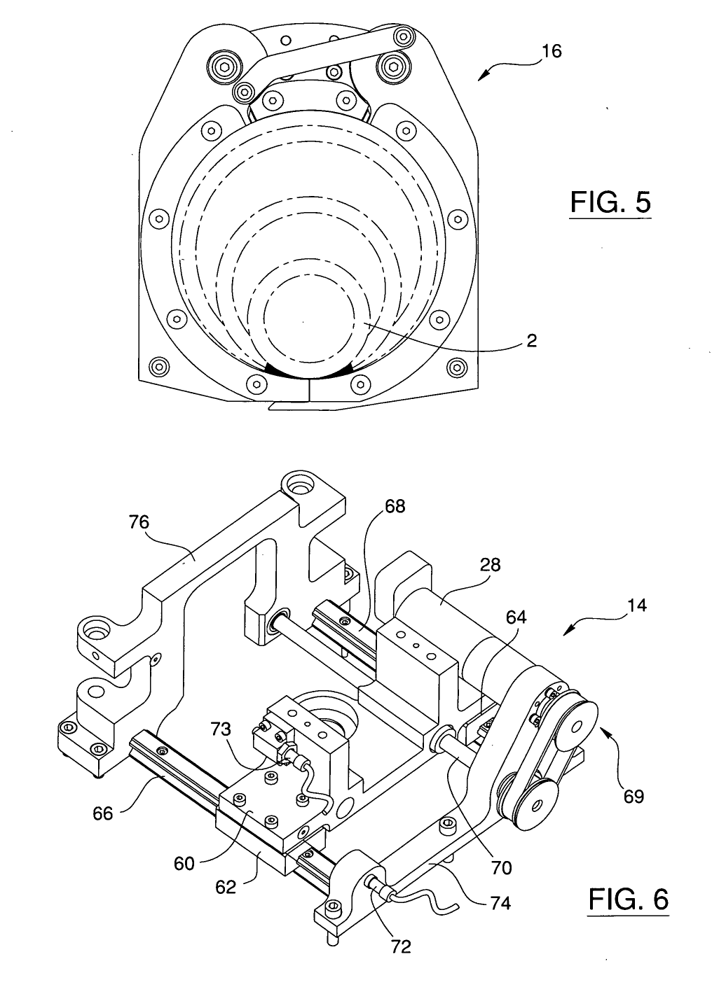

The jaws 34, 36 may advantageously have pivoting arms 35, 37 that cross each other to facilitate the positioning of the pivots 39, 41, 43, 45 of the jaws 34, 36 so that the gripping position of the jaws 34, 36 forwardly moves frontward of the cutting area as the tubular object 2 to be gripped has a reduced diameter, thereby ensuring a positioning of the tubular object 2 toward a front portion of the sealing unit 16 whatever its diameter, as shown in FIG. 5.

The trajectory of the jaws 34, 36 will be determined by the length of the inner faces of the jaws 34, 36 of the clamp 32 and the position of their pivots 39, 41, 43, 45. In order to meet the constraints related to the cutting environment and according to the illustrated configuration of the sealing unit 16, it is preferable that the pipe 2 be positioned on the front portion of the cutting area as tangentially as possible to the circumference or the perimeter of the cutting area. FIG. 5 shows the positions that a pipe 2 will take for pipe diameters of 4.000, 2.875 and 1.900 inches (10.16, 7.30 and 4.83 cm) respectively. The illustrated positioning of the pivots 39, 41, 43, 45 produces a positioning error lower than 1/16 inch (approx. 1.5 mm).

Each of the jaws 34, 36 of the clamp 32 is actuated by the corresponding pneumatic cylinder 33, 35. The pneumatic cylinders 33, 35 have pivotally mounted ends and force the opening and closing of the jaws 34, 36.

Referring to FIG. 6, the advancing unit 14 may advantageously be made of a mechanism having a mobile seating 60 mounted on ball bearing carriages 62, 64 that slide on rails 66, 68 spaced from each other. The cutting unit 12 (as shown in FIG. 1) is mounted on the mobile seating 60. The rails 62, 64 are mounted between support members 74, 76 fastened to the frame 6 (as shown in FIG. 1) and guide a displacement of the mobile seating 60 with respect to the frame 6 so as to move the blade 4 crosswise with respect to the cutting area and vary the cutting depth of the blade 4 in the cutting area. Other guiding mechanisms for the mobile seating 60 may be used if desired.

The seating 60 is actuated by the electric motor 28 via a transmission mechanism 69 coupled to a screw 70, in order to move the seating 60 along the rails 66, 68. The motor 28 is controlled in speed and regulates the rate of removal of metal or other material of which the pipe 2 is made. This type of control limits the variations of constraints in the cutting unit 12 (as shown in FIG. 1) that may be at the source of an accelerated wear of the blade 4 and of certain irregularities during the cutting.

The mechanism of the illustrated advancing unit 14 is capable of providing a considerable advancing force. The use of such power allows stability in the movement without however significantly affecting the weight of the cutting head.

The advancing unit 14 may be provided with two sensors 72, 73 to detect start and end positions of the mobile seating 60. The sensors 72, 73 are respectively fastened on the support member 74 of the drive motor and on the mobile seating 60. Thus, a contact of the mobile seating 60 against the sensor 72 will indicate that the mobile seating 60 is in start position, whereas a contact of the sensor 73 against the support member 76 will indicate that the mobile seating 60 is in end position. The sensor 72 allows in particular calibration and initialization of the system. The sensor 73 can be used to validate that the mobile seating 60 has reached the end position corresponding to the maximum cutting depth. Any other start and end position detecting arrangement of the mobile seating 60 can be used if desired.

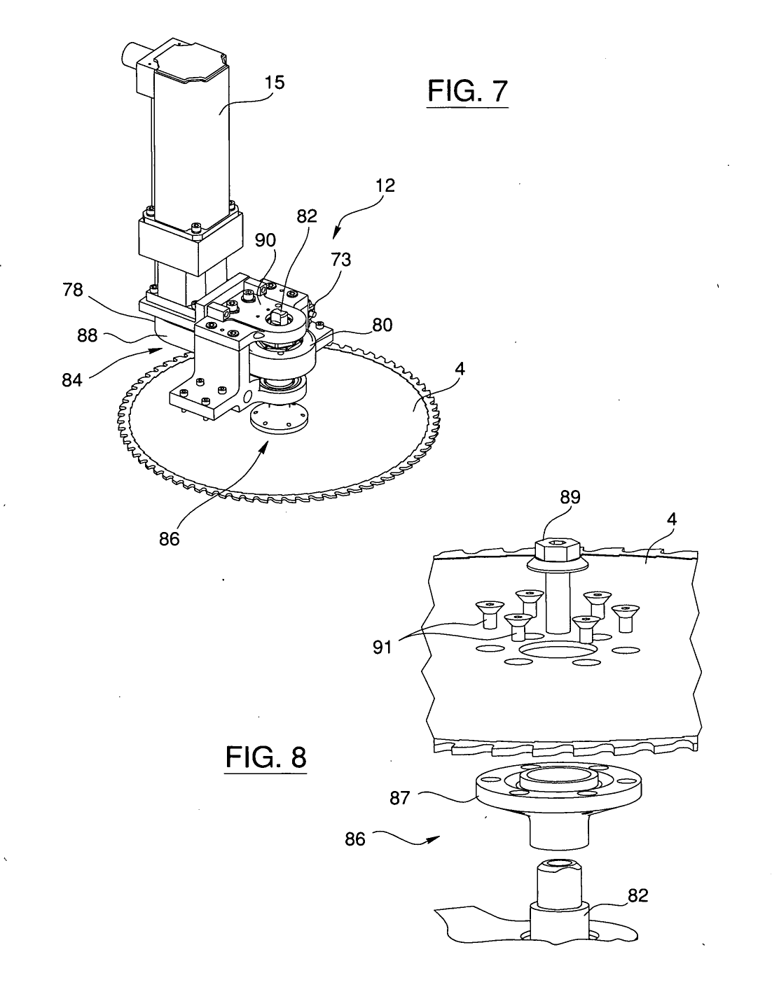

Referring to FIG. 7, the cutting unit 12 is part of the core of the whole. In the case of feeder pipes of nuclear plants, the tool which is recommended for the cutting is a circular saw blade 4 designed for steel. The cutting unit 12 may advantageously comprise a rotating shaft 82, a driving arrangement with a tensioning device 84 coupling the motor 15 to the rotating shaft 82, and a radial fastening arrangement 86 of the blade 4 on the rotating shaft 82. The motor 15 drives the blade 4 by means of two pulleys 78, 80. The driving ratio is preferably adjusted to obtain an optimal range of operating speed at the maximum power of the motor 15. The tensioning device 84 is integrated to the frame 90 of the cutting unit 12 to facilitate the installation of the belt 88 and compensate the possible stretching that the belt 88 may undergo with time. The frame 90 is mounted on and driven by the advancing unit 14 (as shown in FIG. 1) previously described.

Referring to FIG. 8, the fastening arrangement 86 of the blade 4 comprises a flange 87 mounting at the end of the shaft 82, and a set of screws 89, 91 (or other like fastening elements) securing the blade 4 to the flange 87 and the flange 87 to the shaft 82. Such an assembly allows in particular limiting the thickness of the cutting head. The flange 87 allows centering the blade 4 and is used as a mechanical link between the shaft 82 and the blade 4. Other kinds of assemblies of the blade 4 to the shaft 82 may be used if desired.

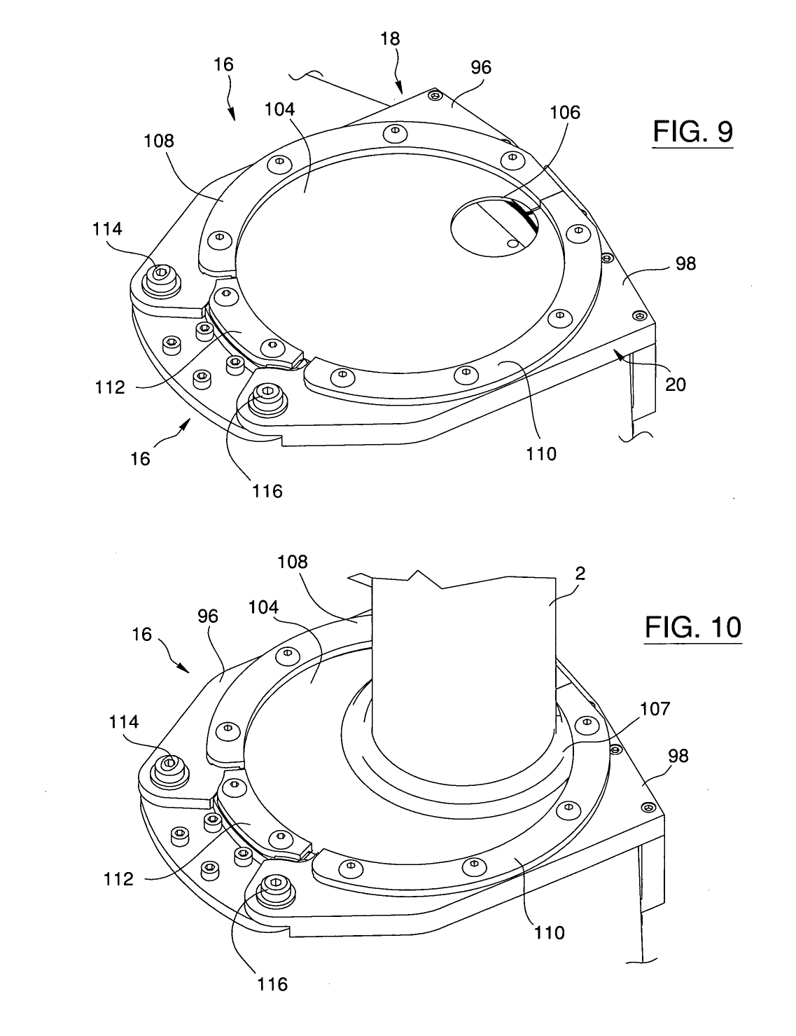

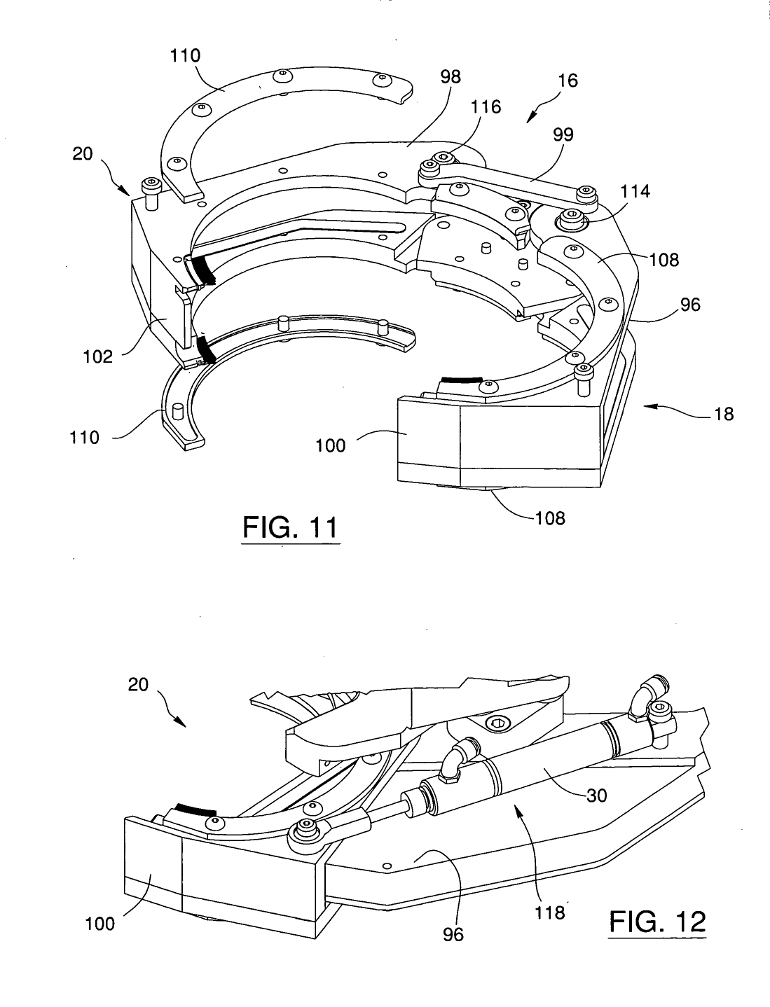

Referring to FIG. 11, the members 18, 20 of the sealing unit 16 comprise mobile jaws 96, 98 operable between an open position, as shown in this Figure, allowing engagement of the tubular object 2 (as shown in FIG. 10) in the cutting area, and a closed position, as shown in FIGS. 9 and 10, in which the jaws 96, 98 extend around the tubular object 2 when it is engaged in the cutting area. The jaws 96, 98 have complementary front faces 100, 102 forming, when the jaws 96, 98 are in closed position, a wall closing a front space of the opening 8 of the frame 6 (as shown in FIG. 1). The jaws 96, 98 may be linked together by a rod 99 so that they are interdependent and pivot in harmony.

Referring to FIGS. 9 and 10, to achieve the sealing of the frame 6 (acting as a guard of the blade 4) around the pipe 2, the cutting head uses elastic membranes 104 (only the upper membrane 104 is shown), preferably made of rubber. The membranes 104 extend between the jaws 96, 98 above and below the opening 8 of the frame 6 (as shown in FIG. 1). The membranes 104 may be fastened to the jaws 96, 98 using attachment inserts 108, 110, 112 (shown in FIG. 11). The membranes 104 preferably extend close to the blade 4.

The membranes 104 have recesses 106 allowing engagement of the tubular object 2 in the cutting area when the jaws 96, 98 are in open position and sealing upper and lower spaces of the opening 8 of the frame 6 around the tubular object 2 when the tubular object 2 is engaged in the cutting area and the jaws 96, 98 are in closed position.

This arrangement has the advantage of being adaptive, highly resistant, passive and easy to use. The natural rubber resists to the heat likely to be produced by the chips and is not sensitive to tears. The membranes 104 must however be thick enough to prevent, when suction is on, the membranes 104 from getting into contact with the blade 4 by suction.

The recesses 106 preferably extend through front portions of the membranes 104. Such a position of the recesses 106, on the mid front of the membranes 104, allows a more uniform distribution of the folds 107 when the membranes 104 are in function. Furthermore, it allows limiting the relative deformation factor and facilitates the opening of the jaws 96, 98.

The geometry of the illustrated jaws 96, 98 is optimized so as to limit the clearance required during the opening. A wise positioning of the pivots 114, 116 allows limiting the expansion of the jaws 96, 98 to less than ¾ inch (1.9 cm). This feature allows facilitating the displacement of the cutting head in a limited space.

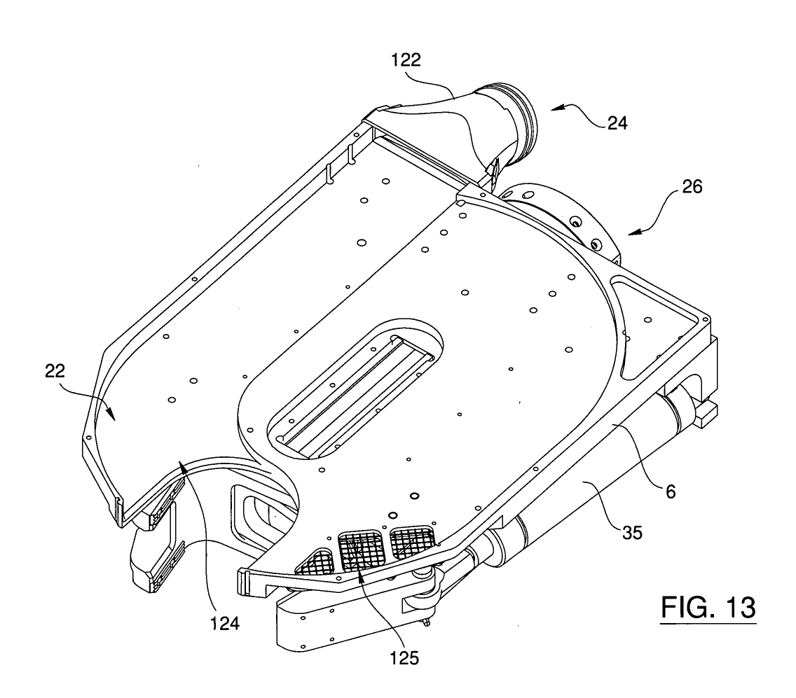

Referring to FIG. 12, the sealing unit 20 comprises an actuating mechanism 118 of the jaws 96, 98 apt to operate them in open position and in closed position. The actuating mechanism 118 may advantageously be made of pneumatic jacks 30, 31 coupled to the jaws 96, 98 and apt to selectively push and pull them toward the open and closed positions (only one of the jacks 30, 31 is shown in the Figure, the other one being shown for example in FIG. 1). The use of pneumatic jacks 30, 31 allows considerably reducing the dimensions of the actuating mechanism 118 compared with other types of actuators such as electric. The pneumatic energy source is in particular clean and easily available.

Referring to FIG. 13, the suction conduit 22 preferably extends through the frame 6 and the chip collecting outlet 24 opens on a rear face of the frame 6. The collecting outlet 24 may advantageously be provided with a suction funnel 122 facilitating the coupling to a suction system (not shown) such as an industrial suction device. The suction conduit 22 has an inlet slot 124 communicating with a lateral face of the chamber generally next to the cutting area and extending frontward of the cutting area. The conduit 22 preferably has a cross-section tapering from the chamber toward the collecting outlet 24. In other words, the space inside the frame 6 leading from the cutting area to the suction funnel 122 thickens up so as to create a conduit (or channel) that directs the chips toward the funnel 122.

A characteristic of the frame 6 is to minimize the clearance between the blade 4 (as shown in FIG. 1) and the body of the frame 6. In addition to accelerating the air flow inside the frame 6, it allows using the blade 4 as a mechanical means for throwing out the splinters.

The arrangement and the positioning of the air inlet 125 of the conduit 22 may have a certain interest depending on the configuration of the cutting head. In the illustrated case, the air inlet 125 is preferably positioned as close as possible upstream from the cutting area. This arrangement promotes the air flow in the cutting area and allows driving most of the particles with the air stream. The area of the air inlet 125 is preferably of identical dimension to the area of the suction funnel 122 in order to preserve the flowing speed.

Changes may be brought to the configuration of the cutting head as function of its intended use. For example, in the case where the thickness of the cutting head is not a critical factor, the configuration and the operation of the cutting unit 12 may then be similar to those of a jigsaw. In such a case, the blade of the cutting unit 12 would then be disposed so as to project completely across the cutting area, and the advancing unit 14 would then be arranged to move the blade sideways in the cutting area rather than forwardly. The conduit 22 could take the form of a suction tube disposed outside the frame 6, preferably alongside thereof, rather than being integrated to the frame 6. The advancing unit 14 may also take other forms in particular if the advancing speed and power are not important factors to be respected, depending on the type of material to be cut. For example, the mobile seating 60 could be mounted in slides and its displacement could be achieved using an appropriate gearing system. Depending on the characteristics of the motor 15, the latter could be integrated in the frame 90 of the cutting unit 12. The gripping unit 10 may also take other forms. For example, the jaws 34, 36 of the clamp 32 may be articulated differently, and their actuation may be achieved using one or several electric motors instead of the pneumatic cylinders 33, 35 if desired. The gripping unit 10 may be combined with the sealing unit 16 if desired, for example by being mounted on the sealing unit 16 or being integrated to the sealing unit 16 that would then be provided with gripping elements (not shown) fulfilling the role of the jaws 34, 36. Different types of actuators, e.g. electrical, hydraulic, may be used instead of pneumatic jacks/cylinders 30, 31, 33, 35 if desired. Instead of elastic membranes 104, the sealing unit 16 may for example comprise a diaphragm mechanism (not shown) made of an assembly of mobile leafs allowing adjusting the diameter of the opening, or a drum mechanism made of a plate bored with several holes of different diameters and mobile so as to allow a given setting. Other changes may be brought to the units of the cutting head as long as these changes provide the useful functions described above.

1. A cutting head with chip collection for cutting a tubular object, comprising:
a frame having an opening defining a cutting area intended to receive the tubular object crosswise;
a gripping unit for gripping the tubular object and securing a position of the tubular object with respect to the frame when the tubular object is engaged in the cutting area;
a cutting unit having a blade for cutting the tubular object, and a motor coupled to the blade for driving it in operation;
a blade advancing unit guiding the cutting unit in order to vary a cutting depth of the blade across the cutting area;
a sealing unit having members extending around the cutting area and forming a chamber around a portion of the tubular object when the tubular object is engaged in the cutting area to contain the chips produced by the blade during a cutting of the tubular object; and
a suction conduit communicating with the chamber for drawing the chips contained in the chamber and conveying them toward a chip collecting outlet disposed away from the cutting area.

2. The cutting head according to claim 1, wherein:
the frame has a substantially flat shape and a front portion comprising the opening; and
the blade is circular and extends in a longitudinal plane of the frame.

3. The cutting head according to claim 2, wherein the advancing unit comprises:
a mobile seating on which the cutting unit is mounted;
a guiding arrangement mounted on the frame and guiding a displacement of the mobile seating with respect to the frame in order to move the blade crosswise with respect the cutting area and vary the cutting depth of the blade in the cutting area; and
a motor for moving the mobile seating with respect to the guiding arrangement.

4. The cutting head according to claim 3, wherein the guiding arrangement comprises rails spaced from each other, and carriages sliding on the rails, the mobile seating being mounted on the carriages.

5. The cutting head according to claim 3, wherein the advancing unit comprises proximity sensors for detecting start and end positions of the mobile seating on the rails.

6. The cutting head according to claim 2, wherein the cutting unit comprises a rotating shaft, a drive system with a tensioning device coupling the motor of the cutting unit to the rotating shaft, and a fastening arrangement of the blade on the rotating shaft.

7. The cutting head according to claim 6, wherein the fastening arrangement comprises a flange mounted on the shaft and receiving the blade, and at least one fastening element screwable in order to secure the blade, the flange and the shaft together.

8. The cutting head according to claim 2, wherein the gripping unit comprises:
a clamp extending below the opening of the frame and having jaws operable between an open position allowing engagement of the tubular object in the cutting area, and a gripping position in which the jaws exert a pressure against the tubular object in order to secure it with respect to the frame; and
actuators coupled to the jaws of the clamp in order to operate the clamp between the open and gripping positions.

9. The cutting head according to claim 8, wherein the jaws have heads exhibiting inner faces incurved toward each other to adapt at least in part to a perimeter of the tubular object, and arms pivoting so that the gripping position of the jaws forwardly moves frontward of the cutting area as the tubular object to be gripped has a reduced diameter, thereby ensuring a positioning of the tubular object toward a front portion of the sealing unit whatever the diameter of the tubular object.

10. The cutting head according to claim 2, wherein the members of the sealing unit comprise:
mobile jaws operable between an open position allowing engagement of the tubular object in the cutting area, and a closed position in which the jaws extend around the tubular objet when the tubular object is engaged in the cutting area, the jaws having complementary front faces forming, when the jaws are in closed position, a wall closing a front space of the opening of the frame; and
elastic membranes extending between the jaws above and below the opening of the frame, the membranes having recesses allowing engagement of the tubular object in the cutting area when the jaws are in open position and sealing upper and lower spaces of the opening of the frame around the tubular object when the tubular object is engaged in the cutting area and the jaws are in closed position.

11. The cutting head according to claim 10, wherein the membranes are in rubber and the recesses extend through front portions of the membranes.

12. The cutting head according to claim 10, wherein the membranes extend close to the blade.

13. The cutting head according to claim 10, wherein the sealing unit comprises an actuation mechanism of the jaws for operating the jaws in open position and in closed position.

14. The cutting head according to claim 13, wherein the actuation mechanism comprises actuators coupled to the jaws for selectively pushing and pulling them toward the open and closed positions.

15. The cutting head according to claim 2, wherein the suction conduit extends through the frame.

16. The cutting head according to claim 15, wherein the chip collecting outlet opens on a rear face of the frame.

17. The cutting head according to claim 16, wherein the collecting outlet is provided with a suction funnel.

18. The cutting head according to claim 15, wherein the suction conduit has an inlet slot communicating with a lateral face of the chamber generally next to the cutting area and extending frontward of the cutting area.

19. The cutting head according to claim 15, wherein the conduit has a cross-section tapering from the chamber toward the collecting outlet.

20. The cutting head according to claim 2, wherein the frame has a rear face provided with a connector for fastening the cutting head to a manipulator arm, the connector having a communication interface for receiving control signals intended to the gripping, cutting, advancing and sealing units.
